(19) United States
(12) Patent Application Publication
(10) Pub. No.: US 2003/0202819 A1
(43) Pub. Date: Oct. 30, 2003

(54) Electrophotographic endless belt, process cartridge, and electrophotographic apparatus

(75) Inventors: Hidekazu Matsuda, Shizuoka (JP); Hiroyuki Kobayashi, Shizuoka (JP); Akihiko Nakazawa, Shizuoka (JP); Atsushi Tanaka, Shizuoka (JP); Tsunenori Ashibe, Kanagawa (JP); Takashi Kusaba, Shizuoka (JP); Ryota Kashiwabara, Shizuoka (JP); Yuji Sakurai, Shizuoka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/372,078

(22) Filed: Feb. 25, 2003

(30) Foreign Application Priority Data
Apr. 26, 2002 (JP) 2002-125995
Jul. 12, 2002 (JP) 2002-204293
Sep. 30, 2002 (JP) 2002-285581

(51) Int. Cl. G03G 15/00

(52) U.S. Cl. 399/121; 399/302

(57) ABSTRACT

In an electrophotographic endless belt having a beltlike substrate, and having a meandering-preventive member for preventing the electrophotographic endless belt from meandering and a position detection member for detecting a prescribed position of the electrophotographic endless belt; the former being disposed on the inner-periphery side of one end portion of the beltlike substrate, and the latter being disposed on the outer-periphery side of the other end portion of the beltlike substrate. The meandering-preventive member and the position detection member are kept apart in a distance of from 200 mm to 250 mm in the width direction of the electrophotographic endless belt. A process cartridge and an electrophotographic apparatus employ such an electrophotographic endless belt as an intermediate transfer belt.

### BACKGROUND OF THE INVENTION

1. Field of the Invention

This invention relates to an electrophotographic endless belt, in particular, an intermediate transfer belt, and also relates to a process cartridge and an electrophotographic apparatus which have the intermediate transfer belt and an electrophotographic photosensitive member.

2. Related Background Art

Besides rigid-body drum-shaped members, flexible endless-belt-shaped members (electrophotographic endless belts) are conventionally used in intermediate transfer belts, electrophotographic photosensitive members, transfer-transport members, fixing members and so forth used in electrophotographic apparatus such as copying machines and laser beam printers.

Usually, in an electrophotographic apparatus, an electrophotographic endless belt is put over, and supported on, at least two rollers disposed on its inner-periphery side and is rotatively driven under application of any desired tension when used.

However, because of any slight errors or scattering in the diameter, deflection, rotating-shaft straightness and roller-to-roller parallelism of the rollers supporting the electrophotographic endless belt, it is inevitable for the electrophotographic endless belt to meander from side to side during its rotating drive.

Such meandering of the electrophotographic endless belt from side to side makes exposure position and transfer position deviate to cause image misregistration. Also, in the case of a full-color electrophotographic apparatus, it makes the position of image formation deviate for each color to cause color misregistration (or color shift) when color toner images are superimposed on the electrophotographic endless belt or on a transfer material transported on the electrophotographic endless belt.

Accordingly, in order to prevent the electrophotographic endless belt from meandering, various methods have ever been proposed. In these recent years, methods in which a meandering-preventive member is provided on the inner periphery of a beltlike substrate of the electrophotographic endless belt to prevent the electrophotographic endless belt from meandering are proposed in a large number.

For example, a method is available in which a roller provided over the whole outer periphery thereof with a groove that may fit in the cross-sectional shape of such a meandering-preventive member is used and an electrophotographic endless belt provided with the meandering-preventive member over the whole inner periphery is rotated making the meandering-preventive member fit in this groove of the roller to prevent the belt from meandering.

As another example, a method is available in which a roller having substantially the same length as the distance between inner sides of meandering-preventive members provided on both ends of a beltlike substrate of an electrophotographic endless belt is used and the belt is put over this roller and is rotated making its both-end meandering-preventive members and the roller fit in each other to prevent the belt from meandering.

As still another example, a method is available in which a roller provided on one end in the axial direction thereof with a terraced portion in which a meandering-preventive member of an electrophotographic endless belt fits is used to prevent the electrophotographic endless belt from meandering.

The above methods can make the electrophotographic endless belt travel smoothly without bringing it into meandering. This enables formation of good images free of any image misregistration or color misregistration.

Meanwhile, usually, where the electrophotographic endless belt is used in an electrophotographic apparatus, it has some means for controlling the position at which a toner image begins to be written.

For example, Japanese Patent Application Laid-Open No. 9-96943 and so forth disclose a method in which a mark (a position detection member) is provided on a beltlike substrate of an electrophotographic endless belt and the writing of an image is started upon detection of this mark. This method is preferable because the detection can very inexpensively be made and also the apparatus can be made compact.

Now, usually, electrophotographic endless belts mostly have a small layer thickness from the viewpoint of making electrophotographic apparatus compact and light-weight, and are also required to have a flexibility to a certain extent because they are used in the state the belt is put over rollers having a small diameter.

On the other hand, the meandering-preventive member fitted to a beltlike substrate of the electrophotographic endless belt is required to have a rigidity high enough to be durable to the draw force of the electrophotographic endless belt.

Where the beltlike substrate of such a thin-film and flexible electrophotographic endless belt is provided with the meandering-preventive member having a rigidity, a slight difference is produced in the degree of flexing of the electrophotographic endless belt when the electrophotographic endless belt is put over the rollers, because there is a difference in stiffness (nerve or rigidity) between the part provided with the meandering-preventive member and the part not provided with it.

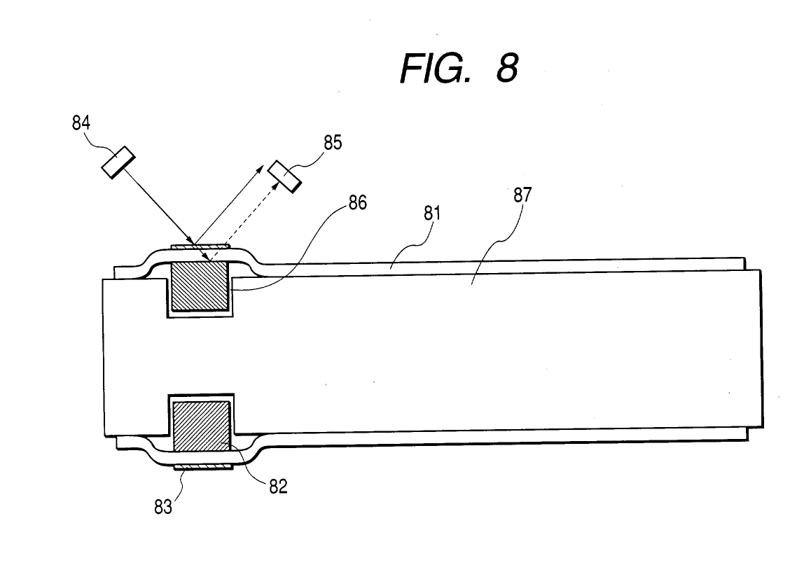

In the case when the meandering-preventive member is provided on the inner periphery of the beltlike substrate of the electrophotographic endless belt and the position detection member is provided on the outer periphery of that part, it has occurred in conventional cases that, as shown in FIG. 8, a meandering-preventive member 82 fitted in a groove 86 of a roller 87 rises because of this slight difference in flexing properties and consequently a beltlike substrate 81 of an electrophotographic endless belt and a position detection member 83 also rise to make any accurate detection impossible to cause image misregistration (reference numeral 84 denotes a light-projecting part of a position detection sensor, and 85 a light-receiving part of the position detection sensor).

It is also the case of the meandering-preventive member that, usually, a member cut beforehand in a length adjusted to the inner-peripheral length of the beltlike substrate is attached to the inner periphery of the beltlike substrate. In such a case, it is unavoidable for the meandering-preventive member to have a joint. In particular, where the position detection member is present on the joint, it is impossible to make any accurate position detection because of an extreme difference in flexing properties. In order to avoid this, the joint of the meandering-preventive member may be avoided when the position detection member is fitted, or the position of the position detection member may be avoided when the meandering-preventive member is fitted. However, taking account of a mass production process, the addition of a step of judging and avoiding the joint of the meandering-preventive member or the position of the position detection member causes a lowering of productivity or an increase in management, resulting in a raise in cost.

Accordingly, as a means for preventing the meandering-preventive member from rising, a method is available in which the tension (belt tension) applied when the electrophotographic endless belt is put over is made higher. There, however, is a possibility that making the tension higher causes a creep of the electrophotographic endless belt to shorten its lifetime. Also, too high belt tension may bring about a possibility of more promoting the meandering of the electrophotographic endless belt.

Conventionally, in order to solve such problems, it has been necessary to use a meandering-preventive member having a relatively low rigidity. However, the use of such a meandering-preventive member having a low rigidity may weaken the effect of preventing the belt from meandering in the width direction. In a bad case, it has even occurred that the meandering-preventive member runs on the roller.

In particular, where a process cartridge in which an electrophotographic photosensitive member and an intermediate transfer belt are integrally supported is used, differently from a case in which it is actually installed and used in the main body of an electrophotographic apparatus, it may often undergo many vibrations or be placed in a high-temperature and high-humidity environment for a long time during distribution in the market. When it is placed in such a severe environment for a long time, the progress of the creep of the belt is accelerated, and moreover the belt may come to have the habit of bending (or permanent bending) as a result of compression set. When the position detection member is present here, a problem may arise such that any accurate position detection can not be made. For such reasons, the above problems may more remarkably arise when the process cartridge in which an electrophotographic photosensitive member and an intermediate transfer belt are integrally supported is used.

### SUMMARY OF THE INVENTION

An object of the present invention is to provide an electrophotographic endless belt which enables formation of good images free of any image misregistration or color misregistration, without causing the problems the method of making the belt tension higher and the method making use of a low-rigidity meandering-preventive member have had.

Another object of the present invention is to provide a process cartridge and an electrophotographic apparatus which have employed the above electrophotographic endless belt as an intermediate transfer belt.

The present invention provides an electrophotographic endless belt having a beltlike substrate, a meandering-preventive member and a position detection member, wherein;

the meandering-preventive member is disposed on the inner-periphery side of one end portion of the beltlike substrate;

the position detection member is disposed on the outer-periphery side of the other end portion of the beltlike substrate; and

the meandering-preventive member and the position detection member are kept apart in a distance of from 200 mm to 250 mm in the width direction of the electrophotographic endless belt.

The present invention also provides a process cartridge and an electrophotographic apparatus which have employed the above electrophotographic endless belt as an intermediate transfer belt.

### BRIEF DESCRIPTION OF THE INVENTION

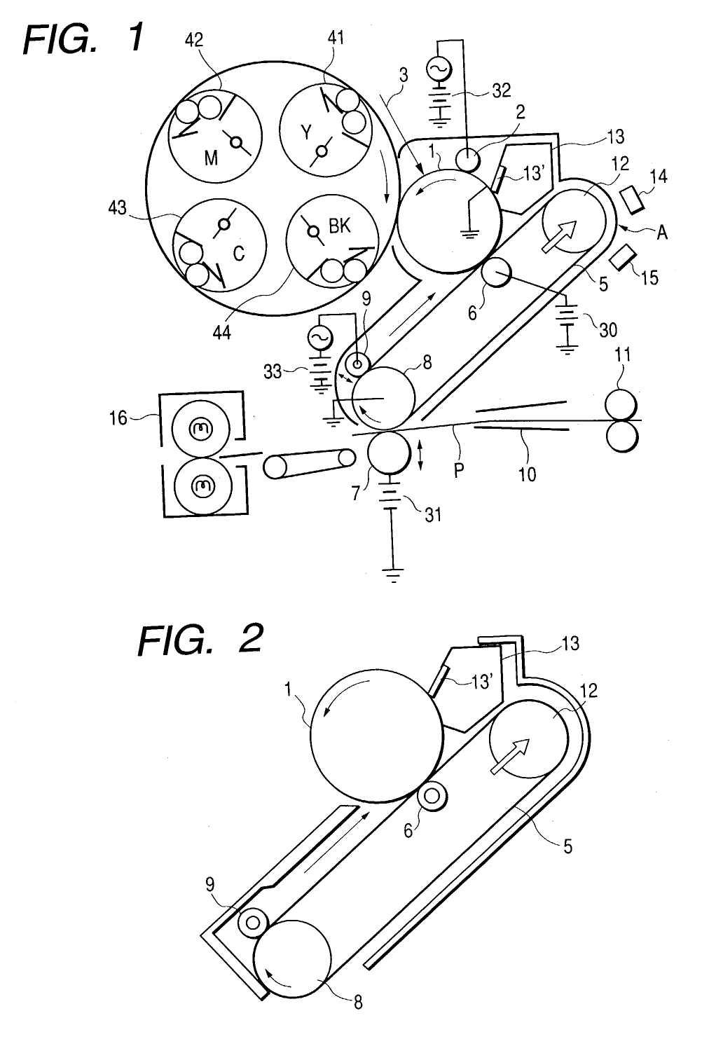

FIG. 1 is a schematic view showing an example of the construction of an electrophotographic apparatus having an intermediate transfer belt/electrophotographic photosensitive member integral process cartridge of the present invention.

FIG. 2 is a schematic view showing an example of the construction of an intermediate transfer belt/electrophotographic photosensitive member integral process cartridge of the present invention.

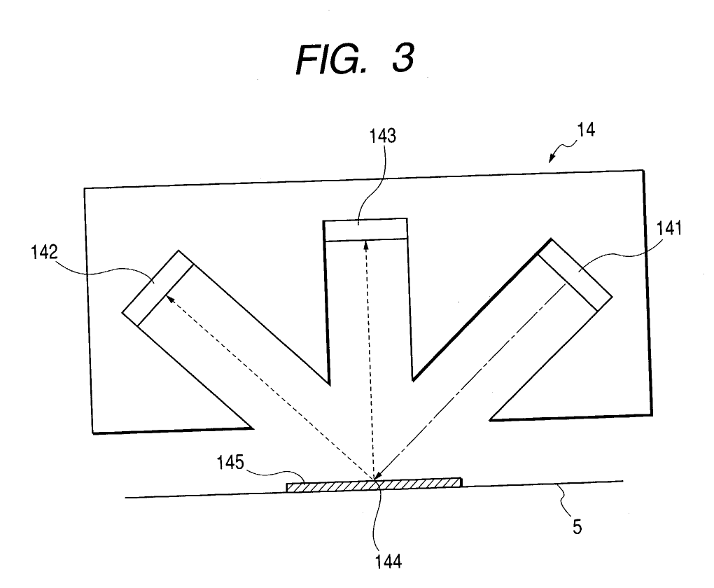

FIG. 3 is a schematic view showing an example of the construction of a density detection sensor.

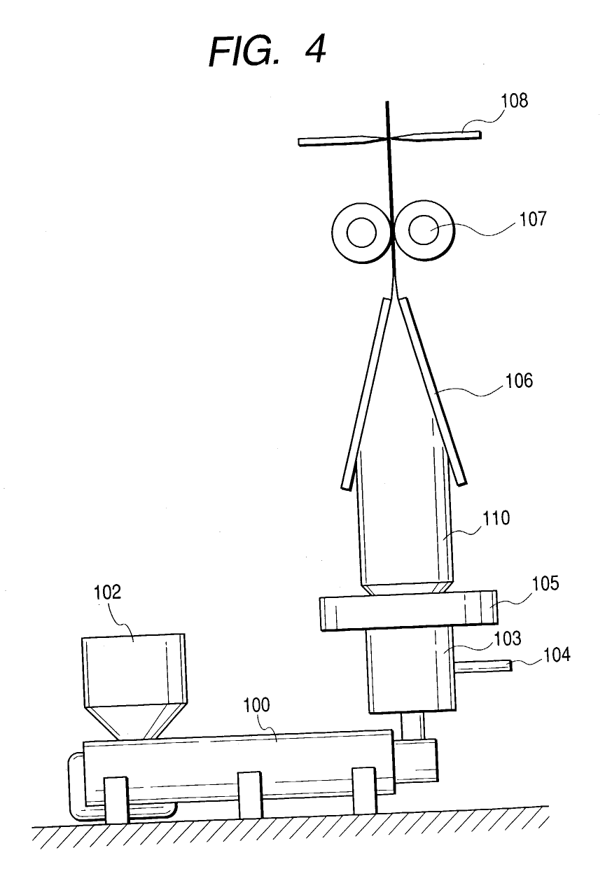

FIG. 4 is a schematic view showing an example of the construction of an extrusion apparatus for forming an intermediate transfer belt (single layer) of the present invention.

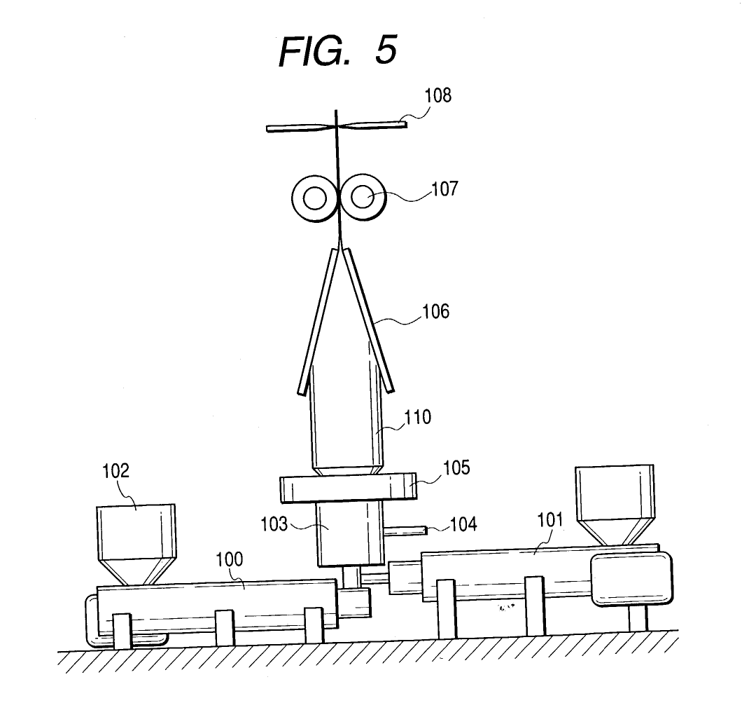

FIG. 5 is a schematic view showing an example of the construction of an extrusion apparatus for forming an intermediate transfer belt (double layer) of the present invention.

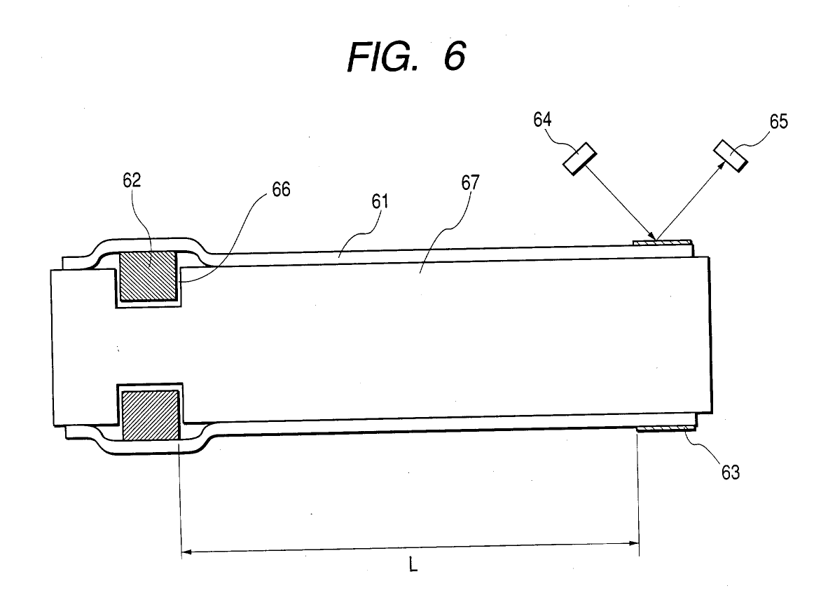

FIG. 6 is a view showing the relationship between the electrophotographic endless belt and the position detection sensor in the present invention and a case in which a roller provided over the whole outer periphery thereof with a groove that may fit in the cross-sectinal shape of the meandering-preventive member is used and an electrophotographic endless belt provided with the meandering-preventive member over the whole inner periphery is rotated while making the meandering-preventive member fit in this groove of the roller to prevent the belt from meandering.

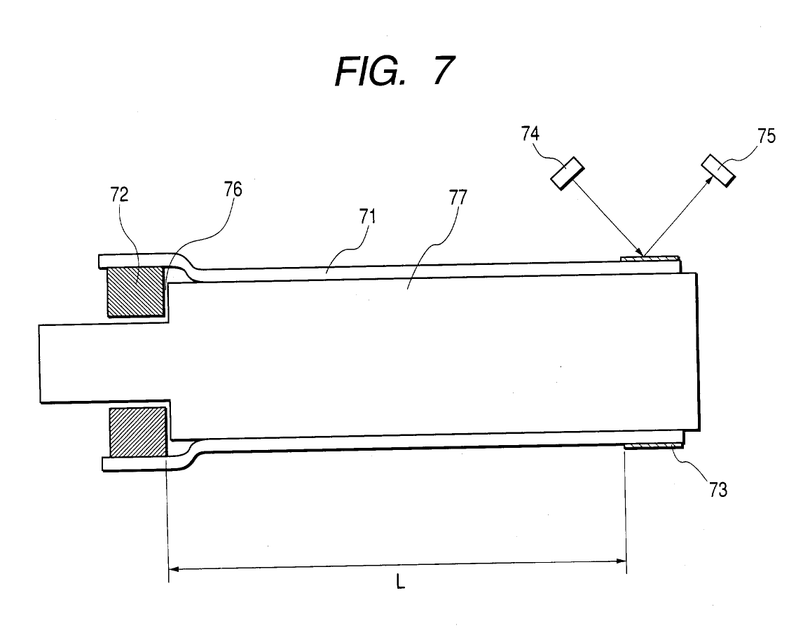

FIG. 7 is a view showing the relationship between the electrophotographic endless belt and the position detection sensor in the present invention and a case in which a roller provided on one end in the axial direction thereof with a terraced portion in which the meandering-preventive member fits is used to prevent the electrophotographic endless belt from meandering.

FIG. 8 is a view showing an electrophotographic endless belt and a position detection sensor in a conventional case.

### DESCRIPTION OF THE PREFERRED EMBODIMENTS

The present invention is described below in detail.

The electrophotographic endless belt of the present invention has a beltlike substrate, a meandering-preventive member and a position detection member. Then, in order to prevent any position detection difference due to a rise at the beltlike substrate surface of the meandering-preventive member, caused by differences in the thickness, physical properties and flexing properties between the beltlike substrate and the meandering-preventive member, as shown in FIG. 6, a meandering-preventive member 62 for preventing the electrophotographic endless belt from meandering is disposed on the inner-periphery side of one end portion of a beltlike substrate 61, and a position detection member 63 for detecting a preset position of the electrophotographic endless belt is disposed on the outer-periphery side of the other end portion of the beltlike substrate 61. Then, the meandering-preventive member 62 and the position detection member 63 are set apart in a distance of from 200 mm to 250 mm. Reference numeral 64 denotes a light-projecting part of a position detection sensor, and 65 a light-receiving part of the position detection sensor. Also, reference numeral 66 denotes a groove in which the meandering-preventive member 62 is fitted.

Shown in FIG. 6 is an embodiment in which a roller 67 provided over the whole outer periphery thereof with the groove 66 that may fit in the cross-sectional shape of the meandering-preventive member 62 is used and the electrophotographic endless belt provided with the meandering-preventive member 62 over the whole inner periphery is rotated making the meandering-preventive member 62 fit in this groove 66 of the roller 67 to prevent the belt from meandering. Instead, as shown in FIG. 7, an embodiment may be employed in which a roller 77 provided on one end in the axial direction thereof with a terraced portion 76 in which the meandering-preventive member fits is used to prevent the electrophotographic endless belt from meandering. In FIG. 7, reference numeral 71 denotes a beltlike substrate; 72, a meandering-preventive member; 73, a position detection member; 74, a light-projecting part of a position detection sensor; 75 a light-receiving part of the position detection sensor; 76, the terraced portion; and 77, the roller over which the electrophotographic endless belt is put.

In FIGS. 6 and 7, letter symbol L denotes the distance between the meandering-preventive member and the position detection member.

If as shown in FIG. 8 the position detection member is fitted to an end on the same side as the end where the meandering-preventive member has been disposed, the position detection member is affected by a rise of the meandering-preventive member to make any accurate detection impossible, resulting in a lowering of the precision of position detection made by the position detection sensor and the position detection member.

The electrophotographic endless belt (beltlike substrate) may also usually have a width ranging from 200 mm to 400 mm. If it has a width of less than 200 mm, the adaptable paper size comes too limited (to be adaptable to, e.g., A4 size). If it has a width of more than 400 nm, it makes the electrophotographic apparatus large-size. Further taking account of the achievement of both an electrophotographic apparatus made compact and the paper size adaptable thereto, the electrophotographic endless belt (beltlike substrate) may preferably have a width ranging from 220 mm to 350 mm.

Accordingly, it is preferable for the meandering-preventive member and position detection member to be set apart in the distance of from 200 mm to 250 mm in the width direction of the electrophotographic endless belt. If their distance is less than 200 mm, not only the position detection precision may lower, but also there is a possibility that they come to the image formation region. If on the other hand it is more than 250 mm, the electrophotographic endless belt comes large in size, consequently making the electrophotographic apparatus large-size.

It is more preferable for the meandering-preventive member and position detection member to be set apart in a distance of from 220 mm to 250 mm.

Setting apart the meandering-preventive member and the position detection member makes it unnecessary to detect the joint of the meandering-preventive member so as to avoid it, and may cause neither lowering of productivity nor rise in cost.

Setting apart the meandering-preventive member and the position detection member can also escape making the belt tension higher than is necessary, and makes it possible for the electrophotographic endless belt to be put over the roller at an appropriate tension. Hence, its creep can be kept from occurring, consequently leading to elongation of the lifetime of the belt. In the present invention, the belt tension may preferably range from 5 N to 70 N.

Setting apart the meandering-preventive member and the position detection member still also makes it possible to use a meandering-preventive member with a high modulus of elasticity, having higher meandering-preventive effect, which has not been used because of its high rigidity, so that the color misregistration or the like can vastly be made less occur. In the present invention, the meandering-preventive member may preferably have a modulus of elasticity ranging from 0.01 Pa to 100 MPa, and more preferably from 0.1 Pa to 50 MPa.

The meandering-preventive member and the position detection member may also preferably be disposed at a place outside the range in which the toner for forming a desired image is to be laid (image formation region) (i.e., disposed at a non-image formation region), and within the range that they do not make the electrophotographic apparatus large-size. If the meandering-preventive member and the position detection member are disposed in the image formation region, images may adversely be affected by a rise of the meandering-preventive member or a bump of the electrophotographic endless belt which is ascribable to the thickness of the position detection member.

The position detection member may also preferably be provided in plurality on the beltlike substrate of the electrophotographic endless belt. If the position detection member is present only at one spot in the peripheral direction of the electrophotographic endless belt, it inevitably takes a long time for the belt to rotate until the position detection member is detected after the switch has been turned on, and there is a possibility of causing a lowering of throughput.

In order to obtain good full-color images, it is necessary as a matter of course to prevent color misregistration by performing accurate position detection. It is also important to assure proper image density. For that reason, a patch is commonly formed on the beltlike substrate of the electrophotographic endless belt to make density control on the basis of the patch. Here, a beltlike substrate whose surface has a high spectral reflectance is preferable because stable and accurate density detection can be performed. If the surface of the beltlike substrate has a low spectral reflectance, not only any accurate position detection may not be performed, but also any proper image density may not be achieved.

FIG. 3 is a schematic view showing an example of the construction of a density detection sensor for performing density detection when the density is controlled on the basis of the patch.

As an optical means for detecting patch density, an optical sensor is used in which a patch 145 is irradiated by light emitted from a light-emitting device 141 such as LED and the amount of reflected light of that light that has depended on the patch density can be detected on specular reflected light and diffused light by means of two light-receiving devices 142 and 143 such as photodiodes.

As the spectral reflectance of the surface of the position detection member, it is preferable to use what is different from the spectral reflectance of the surface of the beltlike substrate of the electrophotographic endless belt. In particular, the spectral reflectance of the position detection member may preferably be made lower than the spectral reflectance of the beltlike substrate surface because there is a tendency that it is preferable for the surface of the beltlike substrate of the electrophotographic endless belt to have a higher spectral reflectance. If the beltlike substrate and the position detection member have the same spectral reflectance, the position detection sensor may perform detection with difficulty to bring about a possibility of damaging its original performance. Stated specifically, the spectral reflectance of the position detection member surface and the spectral reflectance of the beltlike substrate surface may be in a difference of 5 or more. This is preferable because a high sensor output can be obtained and accurate position detection can be performed without any misdetection. If the difference between the spectral reflectance of the position detection member surface and the spectral reflectance of the beltlike substrate surface is less than 5, accurate position detection may be performed with difficulty.

As a method of making the beltlike substrate surface have a high spectral reflectance, it is preferable to incorporate a colorant in the beltlike substrate to form it as a colored layer, or provide a colored layer as a part of the beltlike substrate on its outside.

The colored layer may preferably have a layer thickness of from 40 μm to 200 μm, and more preferably from 50 μm to 150 μm. If it has a layer thickness of less than 40 μm, the incident light may come transmitted through the colored layer to make it difficult to achieve a sufficient reflected-light intensity of the light reflecting from the beltlike substrate surface. If on the other hand the colored layer has a layer thickness of more than 200 μm, the whole electrophotographic endless belt (beltlike substrate) may have so large layer thickness that the belt may come to have the habit of bending at its part put over the rollers, and any accurate reflected light can not be obtained at this part to cause faulty images.

Materials usable as the colorant may include, e.g., white pigments such as titanium oxide, zinc oxide, barium sulfate and silica, blue pigments such as phthalocyanine, red pigments such as dimethylquinacridone, and yellow pigments such as disazo yellow. Of these, white pigments are preferred in view of reflectance and cost. Of the white pigments, zinc oxide and titanium oxide are preferred in view of reflectance, cost and dispersion stability.

The beltlike substrate of the electrophotographic endless belt of the present invention may also preferably have a glossiness of 35 or more. If it has a glossiness of less than 35, it may be difficult to perform accurate density detection when the density is detected. Also, if it has a low glossiness, any good contrast may come not obtainable for both black toner and color toner.

The beltlike substrate of the electrophotographic endless belt of the present invention may include those composed chiefly of thermoplastic resin, thermosetting resin or rubber. Those composed chiefly of thermoplastic resin are preferred.

As the thermoplastic resin, it may include, e.g., olefin resins such as polyethylene and polypropylene, polystyrene resins, acrylic resins, ABS resins, polyester resins (such as PET, PBT, PEN and PAR), polycarbonate resins, sulfur-containing resins such as polysulfone, polyether sulfone and polyphenylene sulfide, fluorine-containing resins such as polyvinylidene fluoride and a polyethylene-tetrafluoroethylene copolymer, polyurethane resins, silicone resins, ketone resins, polyvinylidene chloride, thermoplastic polyimide resins, polyamide resins, modified polyphenylene oxide resins, and various modified resins or copolymers of these, any one or more kinds of which may be used.

When the electrophotographic endless belt is used in the electrophotographic apparatus, it is also necessary to regulate its electrical resistance value adapted to its electrophotographic process.

There are no particular limitations on the additives mixed in order to regulate the electrical resistance value of the intermediate transfer belt (beltlike substrate) of the present invention. As a conductive filler for regulating the resistance, it may include carbon black and various conductive metal oxides. As a non-filler type resistance regulator, it may include low-molecular weight ion conducting materials such as various metal salts and glycols, antistatic resins containing an ether linkage or a hydroxyl group in the molecule, and organic high polymers showing electroconductivity.

There are also no particular limitations on processes for obtaining the beltlike substrate of the electrophotographic endless belt of the present invention. As its forming process, a process for producing a seamless belt may be employed, and a production process having so high a production efficiency as to enable cost saving is preferred. As a method therefor, a method is available in which an extrusion material is continuously melt-extruded from a circular die and thereafter the product thus extruded is cut in any necessary length to produce a belt. For example, blown-film extrusion (inflation) is preferable.

An example of a method of producing the beltlike substrate of the electrophotographic endless belt used in the present invention is described below.

FIG. 4 schematically shows an example of the construction of an extrusion apparatus (blown-film extrusion or inflation apparatus) for forming the beltlike substrate of the electrophotographic endless belt of the present invention. This apparatus consists chiefly of an extruder, an extruder die and a gas blowing unit.

First, materials such as an extrusion resin (which may also be a rubber), a conducting agent and additives are premixed under the desired formulation and thereafter kneaded and dispersed to prepare an extrusion material, which is then put into a hopper 102 installed to an extruder 100.

The extruder 100 has a preset temperature and extruder screw construction which have been so selected that the extrusion material may have a melt viscosity necessary for enabling extrusion into a belt in the post step and also the materials can be dispersed uniformly one another.

The extrusion material is melt-kneaded in the extruder 100 into a melt, which then enters a circular die 103. The circular die 103 is provided with a gas inlet passage 104. Through the gas inlet passage 104, gas (air) is blown into the center of the circular die 103, whereupon the melt having passed through the circular die 103 inflates while scaling up in the diametrical direction to come into a tubular film 110.

The gas to be blown here may be air, and besides may be selected from nitrogen, carbon dioxide and argon.

The extruded product having thus inflated (tubular film) is drawn upward while being cooled by an outside-cooling ring 105. Usually, in such a blown-film extrusion apparatus, a method is employed in which the tubular film 110 is pressed forcibly from the right and the left by means of stabilizing plates 106 to fold it into a sheet, and then drawn off at a constant speed while being so sandwiched with pinch rollers 107 that the air in the interior does not escape.

Then, the tubular film thus drawn off is cut with a cutter 108 to obtain a tubular film with the desired size.

Next, this tubular film is worked using a form (for shaping) in order to regulate its surface smoothness and size and to remove any folds made in the film at the time of draw-off.

Stated specifically, a method is usable which makes use of a set of cylindrical forms made of materials having different coefficient of thermal expansion and having different diameter.

A small-diameter cylindrical form (inner form) has a coefficient of thermal expansion made larger than the coefficient of thermal expansion of a large-diameter cylindrical form (outer form). The tubular film obtained by extrusion is placed over this inner form. Thereafter, the inner form with film is inserted into the outer form so that the tubular film is held between the inner form and the outer form. A gap between the inner form and the outer form may be determined by calculation on the bases of heating temperature, difference in coefficient of thermal expansion between the inner form and the outer form and pressure required.

A form in which the inner form, the tubular film and the outer form have been set in the order from the inside is heated to the vicinity of the softening point temperature of the resin used. As a result of the heating, the inner form, having a larger coefficient of thermal expansion, expands more than the inner diameter of the outer form and hence a uniform pressure is applied to the whole tubular film. Here, the surface of the tubular resin film having reached the vicinity of its softening point is pressed against the inner surface of the outer form having been worked smoothly, so that the smoothness of the surface of the tubular film is improved. Thereafter, these are cooled and the tubular film is removed from the forms, thus smooth surface characteristics can be attained.

It is more preferable to use the above method as a method of obtaining (the beltlike substrate of) an electrophotographic endless belt having small right-and-left difference in inner-peripheral length in order to prevent the belt from meandering.

The foregoing description relates to a single-layer belt. In the case of the endless belt of double-layer construction, an extruder 101 is additionally provided as shown in FIG. 5. Simultaneously with the kneaded melt held in the extruder 100, a kneaded melt in the extruder 101 is sent to a double-layer circular die 103, and the two layers are scale-up inflated simultaneously, thus a double-layer belt can be obtained.

In the case of triple- or more layer construction, the extruder may of course be provided in the number corresponding to the number of layers. Thus, the present invention makes it possible to extrude not only electrophotographic endless belts (beltlike substrates) of single-layer construction but also those of multi-layer construction in a good dimensional precision through one step and also in a short time. The fact that the extrusion can be made in a short time means that mass production and low-cost production can be made.

With regard to the ratio of the thickness of the extruded tubular film to the width of a gap (die slit) of the circular die, the ratio of the former to the latter may preferably be not more than ⅓, and particularly preferably not more than ⅕.

With regard to the ratio of the outer diameter of the tubular film to the outer diameter of the gap (die slit) of the circular die, it may preferably be in the range of from 50% to 400%.

These values represent the state of stretch of the material. If the thickness ratio is more than ⅓, the film may insufficiently stretch to tend to cause difficulties such as low strength, uneven resistance and uneven thickness. As for the ratio of the outer diameter of the tubular film to the outer diameter of the gap (die slit) of the circular die, if it is more than 400% or less than 50%, the film has stretched in excess, resulting in a low extrusion stability or making it difficult to ensure the thickness necessary for the present invention.

In order to achieve preferable spectral reflectance, it is necessary to appropriately control the types and mixing amounts of the extrusion resin (rubber), conductive agent and additives and the state of dispersion of these components. If the conductive agent and additives stand agglomerated or some components stand extremely separate, it is difficult to achieve appropriate spectral reflectance.

Now, the meandering-preventive member of the electrophotographic endless belt according to the present invention may preferably have a thickness of from 0.3 mm to 6 mm. If it has a thickness of less than 0.3 mm, any sufficient meandering-preventive effect may not be obtained and, in some cases, the meandering-preventive member may even run on the roller. If on the other hand it has a thickness of more than 6 mm, the difference between the inner peripheral length of the beltlike substrate of the electrophotographic endless belt and the inner peripheral length of the meandering-preventive member may come so large that, in the actual use of the electrophotographic endless belt, the meandering-preventive member may greatly rise without following up any bend of the electrophotographic endless belt when the electrophotographic endless belt travels over the part where it winds around the roller over which it is put.

To attach the meandering-preventive member to the beltlike substrate, the former may preferably be attached to the latter with a pressure-sensitive adhesive double-coated tape as being inexpensive, enabling attachment in a good precision and being capable of maintaining adherence over a long period of time. Incidentally, the pressure-sensitive adhesive double-coated tape may more preferably be one having a reinforcing base material (support) for its adhesive, in view of working precision, attachment precision, adherence, durability and so forth.

As to materials and characteristics of the reinforcing base material, there are no particular limitations thereon as long as it can maintain the attachment precision. It may include, e.g., sheets of paper such as kraft paper, Japanese paper and crepe paper; single or mixed woven fabrics of rayon (staple fiber), cotton, acetate, glass, polyester and the like Vinylon; fabrics of polyethylene, polypropylene and the like; nonwoven fabrics of rayon, polypropylene, aromatic polyamide, polyester glass and the like; cellophane; films of acetate, polyvinyl chloride, polyethylene, polypropylene and the like; single or mixed rubber sheets of polyurethane rubber, natural rubber, styrene-butadiene rubber, butyl rubber, polychloroprene rubber and the like; and foams of polyurethane, polyethylene, butyl rubber, polychloroprene rubber, acrylic rubber and the like.

Of these, materials which may particularly preferably be used include nonwoven fabrics of rayon, polypropylene, aromatic polyamide, polyester, glass and the like. These have good workability, promise superior working precision and attachment precision, are available at a low price and have the effect of improving adhesive (pressure sensitive) strength greatly. The reinforcing base material of the pressure-sensitive adhesive double-coated tape may preferably have a thickness of from 25 μm to 500 μm.

As a pressure-sensitive adhesive (bonding material) of the pressure-sensitive adhesive double-coated tape, it may include rubber types such as urethane rubber, natural rubbers, styrene-butadiene rubbers, isobutylene rubbers, isoprene rubbers, a styrene-isoprene block copolymer and a styrene-butadiene block copolymer; acrylic types; and silicone types. Also, any of these materials, or any of these and other material, may be used in a combination of two or more. Of these, a pressure-sensitive adhesive double-coated tape making use of an acrylic pressure-sensitive adhesive is preferred as having superior adhesive strength.

As a material of the meandering-preventive member, any material may be used as long as they have a strength high enough to prevent the electrophotographic endless belt from meandering. For example, it may include solids or foams of isoprene rubber, styrene-butadiene rubber, butadiene rubber, ethylene-propylene rubber, chloroprene rubber, nitrile rubber, polyurethane rubber, epichlorohydrin rubber, silicone rubber, fluorine rubber and the like. In particular, polyurethane rubber and silicone rubber are preferred as having compression set superior to that of other materials. Foams of these materials are also preferred as having superior flexibility, having less influence on the flexing properties of the electrophotographic endless and achieving stable belt travel performance.

As the position detection member in the present invention, it may include members having the form of a seal (sticker) and those provided by coating. Taking account of coating precision or squeeze-out of coating materials, those having the form of a seal (position detection seal) are preferred as being attachable in a good precision, suitable for automation and able to achieve both high precision and low cost.

There are no particular limitations on the materials for a base material (support) of the position detection seal, and conventionally known materials may be used. For example, It may include sheets of paper such as kraft paper, Japanese paper and crepe paper; single or mixed woven fabrics of rayon (staple fiber), cotton, acetate, glass, polyester, Vinylon and the like; fabrics of polyethylene, polypropylene and the like; nonwoven fabrics of rayon, polypropylene, aromatic polyamide, polyester, glass; cellophane and the like; films of acetate, polyvinyl chloride, polyethylene, polypropylene, polyester and the like.

As a pressure-sensitive adhesive (bonding material) of the position detection seal, it may include rubber types such as urethane rubber, natural rubbers, styrene-butadiene rubbers, isobutylene rubbers, isoprene rubbers, a styrene-isoprene block copolymer and a styrene-butadiene block copolymer; acrylic types; and silicone types. Also, any of these materials, or any of these and other materials, may be used in a combination of two or more. Of these, a position detection seal making use of an acrylic pressure-sensitive adhesive is preferred as having superior adhesive strength.

As the construction of the position detection seal, it not only may be formed of a simplest combination of a single-layer base material and a single-layer pressure-sensitive adhesive, but also may be constituted of a plurality of base material layers and a plurality of pressure-sensitive adhesive layers as occasion calls, or may be formed in multiple layers by coating or vacuum deposition.

As methods of preparing the position detection seal, conventionally known methods may be employed. A method of preparing it by punching making use of a punching cutter is preferable as promising manufacture in excellent precision, in good productivity and at low cost.

The electrophotographic endless belt of the present invention is also very preferably usable as an intermediate transfer belt for a process cartridge which integrally supports an intermediate transfer belt and an electrophotographic photosensitive member and is detachably mountable to the main body of an electrophotographic apparatus (an intermediate transfer belt/electrophotographic photosensitive member integral process cartridge).

Even where the intermediate transfer belt/electrophotographic photosensitive member integral process cartridge is placed in a severe environment of high temperature and high humidity environment during distribution in the market in the state it is kept put over the rollers for a long term and, by any chance, the meandering-preventive member has caused permanent deformation to have the habit of bending, the process cartridge is by no means influenced by such deformation as long as the intermediate transfer belt which is the electrophotographic endless belt of the present invention is used, because the position detection member is present at the place kept apart at the specific distance from the meandering-preventive member.

Meanwhile, when used as the intermediate transfer belt/electrophotographic photosensitive member integral process cartridge, the process cartridge is handled as an article for consumption. Hence, it is an essential subject that the process cartridge can more inexpensively be manufactured. Accordingly, the component parts constituting it are also desired to be inexpensive. As in the present invention, the pressure-sensitive adhesive double-coated tape commercially available at a low price may be used to attach the meandering-preventive member to the electrophotographic endless belt (intermediate transfer belt). This is preferable because the achievement of a low cost can be materialized. The position detection member may also only be stuck, and this is also preferable because the achievement of a low cost can be materialized.

For the purpose of making the process cartridge compact and achieving cost reduction, it is also preferable to use as a cleaning system of the intermediate transfer belt a cleaning-at-primary transfer method in which secondary-transfer residual toner is charged to a polarity reverse to that at the time of primary transfer and returned from the surface of the intermediate transfer belt to the latent-image-bearing member simultaneously with the primary transfer.

Stated specifically, it is a system in which electric charges with a polarity reverse to that at the time of primary transfer are imparted to the secondary-transfer residual toner by applying a voltage to a charge-providing means (e.g., a charge-providing roller) disposed separably on the intermediate transfer belt, and are returned to the electrophotographic photosensitive member by the aid of a primary-transfer electric field at the subsequent primary-transfer zone. Of course, as the charge-providing means, a corona charging assembly or blade or the like may be used besides the roller. Any means having any shape may be used as long as the electric charges can be imparted to the secondary-transfer residual toner remaining on the intermediate transfer belt.

The toner returned from the surface of the intermediate transfer belt to the electrophotographic photosensitive member is removed by a cleaning means for the electrophotographic photosensitive member, such as a cleaning blade. This system is greatly effective to make the cartridge compact and low-cost.

The intermediate transfer belt may also preferably be of a system in which it is put over two rollers, in view of such an advantage that a drive mechanism is simple, the number of component parts can be made small and the cartridge can be made compact.

Of the rollers over which the intermediate transfer belt is put, a tension roller which applies a tension to the intermediate transfer belt may preferably be slidable by at least 1 mm in respect to the direction in which the intermediate transfer belt elongates. Also, in order for the intermediate transfer belt to be surely driven without slipping, the intermediate transfer belt may preferably be put over the rollers at a force of 5 N or more.

An electrophotographic apparatus is specifically described below which has an intermediate transfer belt/electrophotographic photosensitive member integral process cartridge making use of the electrophotographic endless belt as the intermediate transfer belt.

FIG. 1 is a schematic view showing an example of the construction of an electrophotographic apparatus having an intermediate transfer belt/electrophotographic photosensitive member integral process cartridge (FIG. 2 as referred to later) of the present invention.

In the apparatus shown in FIG. 1, a drum-shaped electrophotographic photosensitive member (photosensitive drum) 1 is rotatively driven at a prescribed peripheral speed (process speed) in the direction of an arrow.

The electrophotographic photosensitive member 1 is, in the course of its rotation, uniformly charged to prescribed polarity and potential by means of a roller-shaped (primary-)charging means (charging roller) 2. Reference numeral 32 denotes a power source for the charging means. A bias formed by superimposing an alternating current on a direct current may be applied, or only a direct-current voltage may be applied.

Subsequently, the electrophotographic photosensitive member is subjected to exposure 3 by an exposure means (not shown; e.g., a color original image color-separating/image-forming optical system, or a scanning exposure system comprising a laser scanner that outputs laser beams modulated in accordance with time-sequential electrical digital pixel signals of image information). Thus, an electrostatic latent image is formed which corresponds to a first color component image (e.g., a yellow color component image) of the intended full-color image.

Next, the electrostatic latent image is developed with a first-color yellow toner Y by means of a first developing means (yellow color developing means 41) to form a yellow toner image. At this stage, second to fourth developing means (magenta color developing means 42, cyan color developing means 43 and black color developing means 44) each stand unoperated and do not act on the electrophotographic photosensitive member 1, and hence the first-color yellow toner image is not affected by the second to fourth developing means.

An intermediate transfer belt 5 is rotatively driven in the direction of an arrow at the same peripheral speed as the electrophotographic photosensitive member 1. The first-color yellow toner image formed and held on the electrophotographic photosensitive member 1 passes through a contact zone between the electrophotographic photosensitive member 1 and the intermediate transfer belt 5, in the course of which it is successively primarily transferred to the outer periphery of the intermediate transfer belt 5 by the aid of an electric field formed by a primary-transfer bias applied from a roller-shaped primary-transfer means (primary-transfer roller) 6 to the intermediate transfer belt 5.

The surface of the electrophotographic photosensitive member 1 from which the corresponding first-color yellow toner image has been transferred to the intermediate transfer belt 5 is cleaned by an electrophotographic photosensitive member cleaning means 13 having a cleaning blade 13′.

Then, the second-color magenta toner image, the third-color magenta toner image and the fourth-color black toner image are sequentially likewise transferred superimposingly onto the intermediate transfer belt 5. Thus, a synthesized full-color toner image corresponding to the intended full-color image is formed on the intermediate transfer belt 5.

Here, the position of the intermediate transfer belt is detected by a position detection sensor 15. The patch for controlling density is also detected by a density detection sensor 14.

A roller-shaped secondary-transfer means (secondary-transfer roller) 7 is provided in such a state that it is axially supported correspondingly, and in parallel, to a secondary-transfer opposing roller 8 and stands separable from the bottom surface of the intermediate transfer belt 5.

The primary transfer bias for sequentially superimposingly transferring the first- to fourth-color toner images from the electrophotographic photosensitive member 1 to the intermediate transfer belt 5 is applied from a bias power source 30 in a polarity (+) reverse to that of each toner. The voltage thus applied may preferably be in the range of from +100 V to +2 kV.

In the step of primarily transferring the first- to third-color toner images from the electrophotographic photosensitive member 1 to the intermediate transfer belt 5, the secondary-transfer roller 7 may also be made to stand separate from the intermediate transfer belt 5.

The synthesized full-color toner image having been transferred onto the intermediate transfer belt 5 is transferred to a second image-bearing member transfer material P in the following way: The secondary transfer roller 7 is brought into contact with the intermediate transfer belt 5 and simultaneously the transfer material P is fed at a prescribed timing from a roller-shaped paper feed means (paper feed roller) 11 through a transfer material guide 10 to the contact zone formed between the intermediate transfer belt 5 and the secondary-transfer roller 7, where a secondary-transfer bias is applied to the secondary-transfer roller 7 from a power source 31. Upon application of this secondary-transfer bias, the synthesized full-color toner image is secondarily transferred from the intermediate transfer belt 5 to the second image-bearing member transfer material P. The transfer material P to which the synthesized full-color toner image has been transferred are guided into a roller-shaped fixing means (fixing roller) 16 and are heat-fixed there.

After the synthesized full-color toner image has been transferred to the transfer material P, a roller-shaped charge-providing means (charge-providing roller) 9 disposed separably is brought into contact with the intermediate transfer belt 5, and a bias with a polarity reverse to that of the electrophotographic photosensitive member 1 is applied, whereupon electric charges with a polarity reverse to that at the time of primary transfer are imparted to secondary-transfer residual toners, not transferred to the transfer material P and remaining on the intermediate transfer belt 5. Reference numeral 33 denotes a bias power source. Here, a bias formed by superimposing an alternating current on a direct current is applied.

The secondary-transfer residual toners charged to the polarity reverse to that at the time of primary transfer are electrostatically transferred to the electrophotographic photosensitive member 1 at the contact zone formed between the intermediate transfer belt 5 and the electrophotographic photosensitive member 1 and the vicinity thereof, thus the intermediate transfer belt 5 is cleaned. This step can be carried out simultaneously with the primary transfer, and hence the though-put does not lower.

The intermediate transfer belt/electrophotographic photosensitive member integral process cartridge of the present invention which is mounted to the electrophotographic apparatus shown in FIG. 1, is described below in greater detail.

FIG. 2 is a schematic view showing an example of the construction of the process cartridge of the present invention.

In the process cartridge shown in FIG. 2, at least an intermediate transfer belt 5, an electrophotographic photosensitive member 1, an electrophotographic photosensitive member cleaning means 13 having a cleaning blade 13′ and a charge-providing means (charge-providing roller) 9 integrally constitute one unit so that it is detachably mountable to the main body of the electrophotographic apparatus.

The cleaning of the intermediate transfer belt 5 employs a system in which the secondary-transfer residual toners are charged to a polarity reverse to that at the time of primary transfer as described previously and thereby returned from the intermediate transfer belt to the electrophotographic photosensitive member at the contact zone between the intermediate transfer belt and the electrophotographic photosensitive member. In the process cartridge shown in FIG. 2, a roller-shaped charge-providing means (charge-providing roller) 9 comprised of a medium-resistance elastic body is provided. Then, the cleaning of the electrophotographic photosensitive member is blade cleaning performed by the cleaning blade 13′. A waste-toner container (not shown) is also integrally provided so that the transfer residual toners on both the intermediate transfer belt and the electrophotographic photosensitive member can simultaneously be discarded when the process cartridge is replaced. Thus, it contributes to an improvement in maintenance performance.

The intermediate transfer belt 5 is also put over two rollers, a secondary-transfer opposing roller 8 and a tension roller 12 so that the number of component parts can be made small and the cartridge can be made compact.

Here, the secondary-transfer opposing roller 8 is a drive roller for driving the intermediate transfer belt and at the same time an opposing roller of the charge-providing roller 9. The tension roller 12, which rotates following the intermediate transfer belt, has a sliding mechanism, and is brought into pressure contact with the inside of the belt in the direction of an arrow by the action of a compression spring to impart a tension to the intermediate transfer belt. It may preferably be slidable in a slide width of from 1 to 5 mm, and the spring may preferably apply a pressure of from 5 to 70 N in total. Also, the electrophotographic photosensitive member 1 and the secondary-transfer opposing roller 8 (serving also as a drive roller) have a coupling (not shown) between them so that the rotational driving force is transmitted from the main body.

In those shown in FIGS. 1 and 2, the secondary-transfer opposing roller 8 (serving also as a drive roller) is also a roller provided on one end in the axial direction thereof with a terraced portion in which the meandering-preventive member of the intermediate transfer belt fits. The tension roller 12 is also a roller provided over the whole outer periphery thereof with a groove that may fit in the cross-sectional shape of the meandering-preventive member of the intermediate transfer belt.

The intermediate transfer belt/electrophotographic photosensitive member integral process cartridge shown in FIG. 2 may be integral at least at the time it is used by users. Taking account of the handling in the course of its manufacture and the readiness to disassemble them after recovery, it is preferable for it to be so designed that it can be divided into some units, e.g., an intermediate transfer belt unit having the intermediate transfer belt and an electrophotographic photosensitive member unit having the electrophotographic photosensitive member.

As a position detection means for detecting the position detection member provided on the electrophotographic endless belt, a conventionally known method may be used. In particular, in the present inventions, it is preferable to use, e.g., a photoelectric sensor (position detection sensor) making use of visible light rays, infrared rays or the like, in particular, a reflection type position detection sensor. If a transmission type sensor is used as the position detection sensor of the electrophotographic endless belt, there are restrictions on materials for the intermediate transfer belt. Especially in the case of the intermediate transfer belt/electrophotographic photosensitive member integral process cartridge as in the present invention, the light-projection part and light-receiving part of the position detection sensor must be put separately on the electrophotographic apparatus main body side and on the process cartridge side. This not only may lower detection precision but also may cause a rise in cost of the process cartridge.

In the foregoing, the present invention has been described mainly on the case in which the electrophotographic endless belt is used as the intermediate transfer belt. Besides the intermediate transfer belt, the electrophotographic endless belt of the present invention are also applicable to the belt at large for which the prevention of meandering and the detection of position are required, such as photosensitive belts, transfer belts, transport belts and fixing belts.

The characteristics in the present invention are all measured in the following manner.

Measurement of Spectral Reflectance:

The spectral reflectance of the electrophotographic endless belt of the present invention and the position detection member used therein refers to spectral reflectance to light of 880 nm in wavelength, and is the value found by measurement with a spectrophotometer UV-310, trade name, manufactured by Shimadzu Corporation (a large-size integrating sphere attachment instrument). Here, its slit width is set to be 5.0 nm, and the sampling pitch 2.0 nm.

Measurement of Glossiness:

The glossiness of the intermediate transfer belt is the value found by measuring with Handy Gloss Meter IG-320 (trade name, manufactured by Horiba Seisakusho K.K.) the glossiness at four spots taken at equal intervals in the peripheral direction at the middle of the belt and averaging the measurements.

Measurement of Layer Thickness:

The layer thickness of the colored layer (beltlike substrate) of the electrophotographic endless belt (intermediate transfer belt) is found, in the case of a single layer, by measuring with a dial gauge the cross sections of samples cut at eight spots at equal intervals over the whole periphery of the middle of the belt and averaging the measurements, and in the case of multiple layers, by observing and measuring such cross sections with an optical microscope and averaging the measurements.

The present invention is described below in greater detail by giving specific working examples. In the following Examples, “part(s)” means part(s) by weight.

### EXAMPLE 1

| | |
|---|---|
| Polyvinylidene fluoride resin (KEINER 720, trade name; | 69.7 parts |
| available from Elfatochem Co.) | |
| Polyether ester amide (PELESTAT NC6321, trade name; | 10 parts |
| available from Sanyo Kasei Kogyo K.K.) | |
| Potassium perfluorosulfonate | 0.3 part |
| Zinc oxide particles (volume-average particle diameter: | 20 parts |
| 0.5 μm) | |

Materials formulated as above were melt-kneaded at 210° C. by means of a twin-screw extruder to mix them, and the kneaded product obtained was extruded in the shape of strands of about 2 mm in diameter, followed by cutting into pellets. This is designated as an extrusion material 1. A beltlike substrate of an intermediate transfer belt was formed by means of the blown-film extrusion apparatus (inflation apparatus) shown in FIG. 4.

In the extrusion apparatus shown in FIG. 4, the extruder die 103 was set as a single-layer circular die, where a die slit outer diameter was 100 mm. The die slit was 0.8 mm in width.

The above extrusion material 1, having been well dried by heating, was put into the hopper 102 of this extrusion apparatus, and heated and melted. The molten product obtained was extruded at 210° C. from the circular die 103. The outside-cooling ring 105 is provided around the circular die 103, and air was blown from the circumference to the film extruded in a tubular form to effect cooling. Also, air was blown to the interior of the extruded tubular film through the gas inlet passage 104 to cause the film to inflate while scaling up until it came to have a diameter of 140 mm. Thereafter, the film was continuously drawn off at a constant speed by means of the draw-off unit. The proportion of the diameter of the circular die 103 to the diameter of the tubular film extruded came to 140%. Here, the air was stopped being fed at the time the diameter came to the desired value. Then, subsequent to the draw-off through the pinch rollers, the tubular film was cut with the cutter 108. After its thickness became uniform, the film was cut in a length of 280 mm to form a tubular film.

On this tubular film, its size and surface smoothness were regulated and folds were removed, using a set of cylindrical forms made of metals having different coefficient of thermal expansion. The tubular film was placed over the cylindrical form (inner form) having a higher coefficient of thermal expansion, and this inner form with film was inserted into the cylindrical form (outer form) having been worked to have a smooth inner surface, followed by heating at 170° C. for 20 minutes. After cooling to room temperature, the tubular film was removed from the inner and outer forms, thus a tubular film whose size and surface smoothness were regulated and from which folds were removed was obtained.

Both ends of this tubular film were precisely cut away to obtain a beltlike substrate of 242 mm in width.

The spectral reflectance of this beltlike substrate was 70%. Also, in this beltlike substrate, the zinc oxide particles stood dispersed in its whole thickness direction, and the beltlike substrate was formed as a white colored layer. The thickness of the colored layer of this beltlike substrate was equal to the thickness of the beltlike substrate itself and was 80 μm. Also, the glossiness of this beltlike substrate was 70.

A pressure-sensitive adhesive double-coated tape comprised of a nonwoven fabric base material of 50 μm in thickness on one side and the other side of which an acrylic pressure-sensitive adhesive was provided respectively in the thickness of 55 μm and 155 μm was stuck to a polyurethane foam of 1.5 mm in thickness in such a way that the 155 μm thick adhesive side was on the polyurethane foam side, and these were cut in a width of 5 mm and a length of 436 mm to make a meandering-preventive member.

Then, a polyethylene terephthalate (PET) film of 50 μm in thickness on one side of which a black coating was provided and on the other side of which an acrylic pressure-sensitive adhesive (20 μm thick) was provided was punched out in 10 mm length×10 mm width to make a position detection seal as the position detection member. The position detection seal was black, and had a spectral reflectance of 8%.

The above meandering-preventive member was attached to one end portion of the beltlike substrate obtained by extrusion as described above, and in the peripheral direction of the inner periphery of the beltlike substrate at a position 4 mm shifted to the middle from the end.

On the outer periphery of the beltlike substrate at its end portion opposite to the end portion to which the meandering-preventive member was attached, the above position detection seal was further stuck along the former's end, at four spots at equal intervals in the peripheral direction of the beltlike substrate, thus an intermediate transfer belt was obtained. The distance between the meandering-preventive member and the position detection seal (position detection member) in the width direction was 223 mm. The meandering-preventive member and the position detection member were both attached at the non-image formation region.

Image Evaluation:

The intermediate transfer belt thus obtained was set in the electrophotographic apparatus constructed as shown in FIG. 1, and full-color images were reproduced on paper of 80 g/m² (basis weight) to conduct a print test. An exposure unit used here was of a 600 dpi digital laser system.

The extent of color misregistration of the images formed was measured to make evaluation. In general, color misregistration in an extent of more than 150 μm is perceivable even with the naked eye. Accordingly, when the extent of color misregistration was more than 150 μm, it was judged that the effect of the present invention had not been obtained.

As a result, the extent of color misregistration was sufficiently as small as 20 μm, and good full-color images were formed. Also, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As a result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 2

| | |
|---|---|
| Polycarbonate resin | 70 parts |
| Polyether ester amide (PELESTAT NC6321) | 10 parts |
| Titanium oxide particles (volume-average particle | 20 parts |
| diameter: 0.05 μm) | |

A beltlike substrate of the intermediate transfer belt was obtained in the same manner as in Example 1 except that the formulation of the extrusion material was changed as shown above and it was made in a belt width of 260 mm.

The same meandering-preventive member and position detection member as those in Example 1 were used.

The meandering-preventive member was attached to one end portion of the beltlike substrate obtained by extrusion as described above, and in the peripheral direction of the inner periphery of the beltlike substrate at a position 5 mm shifted to the middle from the end.

On the outer periphery of the beltlike substrate at its end portion opposite to the end portion to which the meandering-preventive member was attached, the position detection seal was further stuck along the former's end, at four spots at equal intervals in the peripheral direction of the beltlike substrate, thus an intermediate transfer belt was obtained. The distance between the meandering-preventive member and the position detection seal (position detection member) in the width direction was 240 mm. The meandering-preventive member and the position detection member were both attached at the non-image formation region.

The spectral reflectance of the beltlike substrate obtained was 68%. Also, its glossiness was 40. The layer thickness of the colored layer, i.e., beltlike substrate was 80 μm.

The intermediate transfer belt obtained was set in the electrophotographic apparatus constructed as shown in FIG. 1, and an image print test was conducted in the same manner as in Example 1. As a result, the extent of color misregistration was sufficiently as small as 30 μm, and good full-color images were formed. Also, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As a result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 3

| | |
|---|---|
| Polyvinylidene fluoride resin (KEINER 740, trade name; | 70 parts |
| available from Elfatochem Co.) | |
| Potassium perfluorosulfonate (conductive agent) | 8 parts |
| Tin-oxide-coated conductive titanium oxide particles | 12 parts |
| (volume-average particle diameter: 0.02 μm) | |
| Zinc oxide particles (volume-average particle diameter: | 10 parts |
| 0.5 μm) | |

A beltlike substrate of the intermediate transfer belt was obtained in the same manner as in Example 1 except that the formulation of materials for extrusion was changed as shown above. It was in a belt width of 242 mm.

The same meandering-preventive member as that in Example 1 was used.

The meandering-preventive member was attached to one end portion of the beltlike substrate obtained by extrusion as described above, and in the peripheral direction of the inner periphery of the beltlike substrate at a position 5 mm shifted to the middle from the end.

At four spots at equal intervals on the outer periphery of the beltlike substrate at its end portion opposite to the end portion to which the meandering-preventive member was attached, a black coating material was further applied in 10 mm square each to make them serve as the position detection member, thus an intermediate transfer belt was obtained. The distance between the meandering-preventive member and the position detection seal (position detection member) in the width direction was 222 mm. The meandering-preventive member and the position detection member were both attached at the non-image formation region.

The spectral reflectance of the beltlike substrate obtained was 62%. Also, its glossiness was 64.2. The layer thickness was 100 μm. The spectral reflectance of the position detection member was 10%.

The intermediate transfer belt obtained was set in the electrophotographic apparatus constructed as shown in FIG. 1, and an image print test was conducted in the same manner as in Example 1. As a result, the extent of color misregistration was sufficiently as small as 40 μm, and good full-color images were formed. Also, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As the result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 4

| | |
|---|---|
| Polyvinylidene fluoride resin (KEINER 720) | 99 parts |
| Lithium perchlorate powder | 1 part |

An inside tubular film was obtained in the same manner as the beltlike substrate in Example 1except that the formulation of materials for extrusion was changed as shown above and it was formed in a layer thickness of 70 μm.

An outside tubular film was also obtained in the same manner as the beltlike substrate in Example 1 except that materials for extrusion formulated as shown below were used and it was formed in a layer thickness of 30 μm.

| | |
|---|---|
| Polyvinylidene fluoride resin (KEINER 720) | 70 parts |
| Polyether ester amide (PELESTAT NC6321) | 10 parts |
| Zinc oxide particles (volume-average particle diameter: | 20 parts |
| 0.5 μm) | |

A beltlike substrate was obtained in the same manner as in Example 1 except that the inside tubular film and the outside tubular film were so superposed that the former was on the inside and the latter was on the outside and these films were joined together and adjusted on their sizes and surface smoothnesses, using a set of cylindrical forms made of a metal, having different coefficients of thermal expansion. It was in a belt width of 242 mm.

The same meandering-preventive member and position detection member as those in Example 1 were used.

The meandering-preventive member was attached to one end portion of the beltlike substrate obtained by extrusion as described above, and in the peripheral direction of the inner periphery of the beltlike substrate at a position 5 mm shifted to the middle from the end.

On the outer periphery of the beltlike substrate at its end portion opposite to the end portion to which the meandering-preventive member was attached, the position detection seal was further stuck along the former's end, at four spots at equal intervals in the peripheral direction of the beltlike substrate, thus an intermediate transfer belt was obtained. The distance between the meandering-preventive member and the position detection seal (position detection member) in the width direction was 222 mm. The meandering-preventive member and the position detection member were both attached at the non-image formation region.

The spectral reflectance of the beltlike substrate obtained was 52% because the thickness of the colored layer (colorant-containing layer) formed out of the above outside tubular film was so small that most incident light was transmitted. Also, its glossiness was 67. The layer thickness of the colorant-containing layer was 30 μm. The spectral reflectance of the position detection member was 8%.

The intermediate transfer belt obtained was set in the electrophotographic apparatus constructed as shown in FIG. 1, and an image print test was conducted in the same manner as in Example 1. As a result, the extent of color misregistration was sufficiently as small as 45 μm, and good full-color images were formed. Also, though not as good as in Example 1, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As a result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 5

A beltlike substrate was obtained in the same manner as in Example 1. As the meandering-preventive member, the same one as in Example 1 was attached to the same position. Also, as the position detection member, it was provided in the same manner as in Example 1 except that it was formed by applying a gray coating material. Thus, an intermediate transfer belt was obtained.

The spectral reflectance of this position detection member was 67%. The spectral reflectance of the position detection member was lower than the spectral reflectance of the beltlike substrate, and the difference between them was 3. Also, the glossiness of the beltlike substrate was 70.

The intermediate transfer belt obtained was set in the electrophotographic apparatus constructed as shown in FIG. 1, and an image print test was conducted in the same manner as in Example 1. As a result, the extent of color misregistration was sufficiently as small as 70 μm, and good full-color images were formed. Also, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As a result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 6

A beltlike substrate was obtained in the same manner as in Example 1. As the meandering-preventive member, the same one as in Example 1 was attached to the same position. Also, as the position detection member, it was provided in the same manner as in Example 1 except that the PET film was vacuum-deposited with aluminum. Thus, an intermediate transfer belt was obtained.

The spectral reflectance of this position detection member was 80%. The spectral reflectance of the position detection member was higher than the spectral reflectance of the beltlike substrate, and the difference between them was 10. Also, the glossiness of the beltlike substrate was 70.

The intermediate transfer belt obtained was set in the electrophotographic apparatus constructed as shown in FIG. 1, and an image print test was conducted in the same manner as in Example 1. As a result, although the sequence on the side of the main body of the electrophotographic apparatus had to be rewritten because the spectral reflectance of the position detection member and that of the beltlike substrate stood reverse, the extent of color misregistration was sufficiently as small as 70 μm, and good full-color images were formed. Also, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As a result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 7

A beltlike substrate was obtained in the same manner as in Example 1 except that it was made in a thickness of 250 μm as the colored layer. The same meandering-preventive member and position detection member as those in Example 1 were attached to the same positions to obtain an intermediate transfer belt.

The spectral reflectance of this beltlike substrate was 74%. Also, the glossiness of the beltlike substrate was 70.

The intermediate transfer belt obtained was set in the electrophotographic apparatus constructed as shown in FIG. 1, and an image print test was conducted in the same manner as in Example 1. As a result, although the belt was so thick as to have poor flexing properties to make position detection unstable, the extent of color misregistration was 90 μm, and the belt was well usable. Also, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As a result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 8

A beltlike substrate was obtained in the same manner as in Example 1 except that it was made in a thickness of 150 μm as the colored layer. The same meandering-preventive member and position detection member as those in Example 1 were attached to the same positions to obtain an intermediate transfer belt.

The spectral reflectance of this beltlike substrate was 72%. Also, the glossiness of the beltlike substrate was 70.

The intermediate transfer belt obtained was set in the electrophotographic apparatus constructed as shown in FIG. 1, and an image print test was conducted in the same manner as in Example 1. As a result, the extent of color misregistration was 70 μm, which was on a good level. Also, the density was detectable in respect of all densities in all the black, yellow, magenta and cyan colors, and development bias conditioning the image formation was well controllable, so that images with proper density were formed.

Subsequently, a running test was conducted by continuous printing on 5,000 sheets at a process speed of 4 sheets per minute to make image evaluation in the same way. As a result, good images almost free of color misregistration like those at the initial stage were formed. Also, the density was detectable in respect of all densities in all the black, yellow, magenta and cyan colors like those at the initial stage, and development bias conditioning the image formation was well controllable. Thus, it was confirmed that this intermediate transfer belt had good performance. Any color misregistration that had gone beyond tolerance limits did not occur in printing at the initial stage and in the course of running, and images with proper density were formed.

### EXAMPLE 9

| | |
|---|---|
| Polyvinylidene fluoride resin (KEINER 720) | 69.7 parts |
| Polyether ester amide (PELESTAT NC6321) | 10 parts |
| Potassium perfluorosulfonate | 0.3 part |
| Carbon black for coloring | 20 parts |

A beltlike substrate of the intermediate transfer belt was obtained in the same manner as in Example 1 except that the formulation of materials for extrusion was changed as shown above. The same meandering-preventive member and position detection member as in Example 1 were attached to the same positions to obtain an intermediate transfer belt.

The spectral reflectance of this beltlike substrate was 15%. Also, the glossiness of the beltlike substrate was 50.

The intermediate transfer belt obtained was set in the electrophotographic apparatus constructed as shown in FIG. 1, and an image print test was conducted in the same manner as in Example 1. As a result, the extent of color misregistration was 70 μm, which was on a good level. Also, the density a little deviated from the desired density because of a little low spectral reflectance of the belt, but images with a density within a well usable range were formed.

Subsequently, a running test was conducted by continuous printing on 5,000 sheets at a process speed of 4 sheets per minute to make image evaluation in the same way. As a result, good images almost free of color misregistration like those at the initial stage were formed. Any color misregistration that had gone beyond tolerance limits did not occur in printing at the initial stage and in the course of running, and image density was also within a well usable range.

### EXAMPLE 10

A beltlike substrate was obtained in the same manner as in Example 1 except that an outer form whose inner surface was subjected to honing was used. The same meandering-preventive member and position detection member as those in Example 1 were attached to the same positions to obtain an intermediate transfer belt.

The spectral reflectance of this beltlike substrate was 65%. Also, the glossiness of the beltlike substrate was as low as 30 because the inner surface of the outer form had a little large surface roughness.

The intermediate transfer belt obtained was set in the electrophotographic apparatus constructed as shown in FIG. 1, and an image print test was conducted in the same manner as in Example 1. As the result, the extent of color misregistration was 70 μm, which was on a good level. Also, the density a little deviated from the desired density because of a little low glossiness of the belt, but images with a density within a well usable range were formed.

Subsequently, a running test was conducted by continuous printing on 5,000 sheets at a process speed of 4 sheets per minute to make image evaluation in the same way. As the result, good images almost free of color misregistration like those at the initial stage were formed. Also, the image density was within a well usable range. Thus, it was confirmed that this intermediate transfer belt had good performance. Any color misregistration that had gone beyond tolerance limits did not occur in printing at the initial stage and in the course of running, and image density was also within a well usable range.

### Comparative Example 1

The same beltlike substrate, meandering-preventive member and position detection member as in Example 1 were used.

The meandering-preventive member was attached to one end portion of the beltlike substrate obtained by extrusion as described above, and in the peripheral direction of the inner periphery of the beltlike substrate at a position 3 mm shifted to the middle from the end.

On the outer periphery of the beltlike substrate at its end portion to which the meandering-preventive member was attached, the position detection seal was further stuck along the former's end, at four spots at equal intervals in the peripheral direction of the beltlike substrate, thus an intermediate transfer belt was obtained. The meandering-preventive member and the position detection seal (position detection member) were on the inside and outside of the same end portion. The meandering-preventive member and the position detection member were both attached at the non-image formation region.

The intermediate transfer belt obtained was set in the electrophotographic apparatus constructed as shown in FIG. 1, and an image print test was conducted in the same manner as in Example 1. As a result, although the image density was proper, the extent of color misregistration was 200 μm from the beginning, which had gone beyond tolerance limits.

### Comparative Example 2

| | |
|---|---|
| Polycarbonate resin | 85 parts |
| Conductive carbon black (primary average particle | 15 parts |
| diameter: 40 nm) | |

A beltlike substrate of the intermediate transfer belt was obtained in the same manner as in Example 1 except that the formulation of the extrusion material was changed as shown above. It was made in a belt width of 242 mm.

The same meandering-preventive member and position detection member as in Example 1 were used.

The meandering-preventive member was attached to one end portion of the beltlike substrate obtained by extrusion as described above, and in the peripheral direction of the inner periphery of the beltlike substrate at a position 3 mm shifted to the middle from the end.

On the outer periphery of the beltlike substrate at its end portion to which the meandering-preventive member was attached, the position detection seal was further stuck along the former's end, at four spots at equal intervals in the peripheral direction of the beltlike substrate, thus an intermediate transfer belt was obtained. The meandering-preventive member and the position detection seal (position detection member) were on the inside and outside at the same end portion. The meandering-preventive member and the position detection member were both attached at the non-image formation region.

The beltlike substrate obtained was in a layer thickness of 100 μm, a spectral reflectance 12% and a glossiness of 60.

The intermediate transfer belt obtained was set in the electrophotographic apparatus constructed as shown in FIG. 1, and a full-color image print test was conducted in the same manner as in Example 1. As a result, the position of the intermediate transfer belt was not detectable, and the printing was not performable.

### Comparative Example 3

| | |
|---|---|
| Polyvinylidene fluoride resin (KEINER 720) | 99 parts |
| Lithium perchlorate particles | 1 part |

An inside tubular film was obtained in the same manner as the beltlike substrate in Example 1 except that the formulation of materials for extrusion was changed as shown above and it was formed in a layer thickness of 70 μm.

An outside tubular film was also obtained in the same manner as the beltlike substrate in Example 1 except that materials for extrusion formulated as shown below were used and it was formed in a layer thickness of 30 μm.

| | |
|---|---|
| Polyvinylidene fluoride resin (KEINER 720) | 70 parts |
| Polyether ester amide (PELESTAT NC6321) | 10 parts |
| Zinc oxide particles (volume-average particle diameter: | 20 parts |
| 0.5 μm) | |

A beltlike substrate was obtained in the same manner as in Example 1 except that the inside tubular film and the outside tubular film were so superposed that the former was on the inside and the latter was on the outside and these films were joined together and adjusted on their sizes and surface smoothnesses, using a set of cylindrical forms made of a metal, having different coefficients of thermal expansion. It was in a belt width of 242 mm.

The spectral reflectance of the beltlike substrate obtained was 20%, its glossiness was 66, and the layer thickness of the colored layer formed of the above tubular film for outside was 30 μm.

The same meandering-preventive member and position detection member as those in Example 1 were used.

The meandering-preventive member was attached to one end portion of the beltlike substrate obtained by extrusion as described above, and in the peripheral direction of the inner periphery of the beltlike substrate at a position 3 mm shifted to the middle from the end.

On the outer periphery of the beltlike substrate at its end portion to which the meandering-preventive member was attached, the position detection seal was further stuck along the former's end, at four spots at equal intervals in the peripheral direction of the beltlike substrate, thus an intermediate transfer belt was obtained. The meandering-preventive member and the position detection seal (position detection member) were on the inside and outside at the same end portion. The meandering-preventive member and the position detection member were both attached at the non-image formation region.

The intermediate transfer belt obtained was set in the electrophotographic apparatus constructed as shown in FIG. 1, and a full-color image print test was conducted in the same manner as in Example 1. As a result, the extent of color misregistration was 300 μm, and the density of black was not within a proper range.

### Comparative Example 4

A beltlike substrate was obtained in the same manner as in Example 1 except that the outer form used to adjust the size and surface smoothness and remove folds was changed for an outer form whose inner surface was subjected to honing.

The spectral reflectance of the beltlike substrate obtained was 70%, its glossiness was 30, and the layer thickness of the colored layer, i.e., beltlike substrate was 80 μm.

The same meandering-preventive member and position detection member as in Example 1 were used.

The meandering-preventive member was attached to one end portion of the beltlike substrate obtained by extrusion as described above, and in the peripheral direction of the inner periphery of the beltlike substrate at a position 3 mm shifted to the middle from the end.

On the outer periphery of the beltlike substrate at its end portion to which the meandering-preventive member was attached, the position detection seal was further stuck along the former's end, at four spots at equal intervals in the peripheral direction of the beltlike substrate, thus an intermediate transfer belt was obtained. The meandering-preventive member and the position detection seal (position detection member) were on the inside and outside at the same end portion, so that the distance between them in the width direction was 0 mm. The meandering-preventive member and the position detection member were both attached at the non-image formation region.

The intermediate transfer belt obtained was set in the electrophotographic apparatus constructed as shown in FIG. 1, and a full-color image print test was conducted in the same manner as in Example 1. As the result, the extent of color misregistration was as large as 400 μm, and images with proper density were not formed in respect of both black and other colors.

The results of evaluation in the Examples and Comparative Examples are shown in Table 1. In the table, with regard to the evaluation of image density, it was ranked in the order of grade of:

A: Proper density.

B: Density with no problem.

C: Not proper density.

TABLE 1

| | | Distance between | | | | | | | |
|---|---|---|---|---|---|---|---|---|---|
| | Intermediate | meandering = | Spectral reflectance of: | | | Layer | | Evaluation | |
| | transfer | preventive member | belt-like | position | | thickness of | | Color | |
| | belt | and position | substrate | detection | Difference | colored | Belt-like | mis- | |
| | width | detection member | A | member B | bet. | layer | substrate | registration | Image |
| | (mm) | (mm) | (%) | (%) | A & B | (μm) | glossiness | (μm) | density |
| Example: | | | | | | | | | |
| 1 | 242 | 223 | 70 | 8 | 62 | 80 | 70 | 20 | A |
| 2 | 260 | 240 | 68 | 8 | 60 | 80 | 40 | 30 | A |
| 3 | 242 | 222 | 62 | 10 | 52 | 100 | 64.2 | 40 | A |
| 4 | 242 | 222 | 52 | 8 | 44 | 30 | 67 | 45 | B |
| 5 | 242 | 223 | 70 | 67 | 3 | 80 | 70 | 70 | A |
| 6 | 242 | 223 | 70 | 80 | 10 | 80 | 70 | 70 | A |
| 7 | 242 | 223 | 74 | 8 | 66 | 250 | 70 | 90 | A |
| 8 | 242 | 223 | 72 | 8 | 64 | 150 | 70 | 70 | A |
| 9 | 242 | 223 | 15 | 8 | 7 | 80 | 50 | 70 | B |
| 10 | 242 | 223 | 65 | 8 | 57 | 80 | 30 | 70 | B |
| Comparative | | | | | | | | | |
| Example: | | | | | | | | | |
| 1 | 242 | End portion on | 70 | 8 | 62 | 80 | 70 | 200 | A |
| | | the same side. | | | | | | | |
| 2 | 242 | End portion on | 12 | 8 | 4 | 100 | 60 | — | — |
| | | the same side. | | | | | | | |
| 3 | 242 | End portion on | 20 | 8 | 12 | 30 | 66 | 300 | C |
| | | the same side. | | | | | | | |
| 4 | 242 | End portion on | 70 | 8 | 62 | 80 | 30 | 400 | C |
| | | the same side. | | | | | | | |

According to the present invention, an electrophotographic endless belt can be provided which contributes to the formation of high-quality images having less color misregistration or image misregistration because of good meandering prevention and accurate position detection.

According to the present invention, an electrophotographic endless belt can also be provided which contributes to the formation of good images because of accurate and stable density detection.

According to the present invention, an intermediate transfer belt comprised of the above electrophotographic endless belt, and a process cartridge and an electrophotographic apparatus which have such an intermediate transfer belt, can also be provided.

What is claimed is:

1. An electrophotographic endless belt comprising a beltlike substrate, a meandering-preventive member and a position detection member, wherein;
said meandering-preventive member is disposed on the inner-periphery side of one end portion of said beltlike substrate;
said position detection member is disposed on the outer-periphery side of the other end portion of said beltlike substrate; and
said meandering-preventive member and said position detection member are kept apart in a distance of from 200 mm to 250 mm in the width direction of the electrophotographic endless belt.

2. The electrophotographic endless belt according to claim 1, wherein said meandering-preventive member and said position detection member are kept apart in a distance of from 220 mm to 250 mm in the width direction of the electrophotographic endless belt.

3. The electrophotographic endless belt according to claim 1, wherein said meandering-preventive member and said position detection member are each disposed in a non-image formation region of said beltlike substrate.

4. The electrophotographic endless belt according to claim 1, wherein the surface of said beltlike substrate has a spectral reflectance higher than that of the surface of said position detection member.

5. The electrophotographic endless belt according to claim 4, wherein the spectral reflectance of the surface of said beltlike substrate and the spectral reflectance of the surface of said position detection member is in a difference of 5 or more.

6. The electrophotographic endless belt according to claim 1, wherein said beltlike substrate comprises a colored layer containing a colorant, and the colored layer has a layer thickness of from 40 μm to 200 μm.

7. The electrophotographic endless belt according to claim 6, wherein said colorant is a white pigment.

8. The electrophotographic endless belt according to claim 1, wherein said beltlike substrate has a glossiness of 35 or more.

9. The electrophotographic endless belt according to claim 1, which is an intermediate transfer belt.

10. A process cartridge comprising an intermediate transfer belt and being detachably mountable to the main body of an electrophotographic apparatus; said intermediate transfer belt being an intermediate transfer belt having a beltlike substrate, a meandering-preventive member and a position detection member; wherein;
said meandering-preventive member is disposed on the inner-periphery side of one end portion of said beltlike substrate;
said position detection member is disposed on the outer-periphery side of the other end portion of said beltlike substrate; and
said meandering-preventive member and said position detection member are kept apart in a distance of from 200 mm to 250 mm in the width direction of the electrophotographic endless belt.

11. The process cartridge according to claim 10, wherein at least an electrophotographic photosensitive member for holding a toner image thereon and said intermediate transfer belt are integrally supported; said belt being to form a contact zone between itself and the electrophotographic photosensitive member.

12. The process cartridge according to claim 10, wherein said meandering-preventive member and said position detection member are kept apart in a distance of from 220 mm to 250 mm in the width direction of the electrophotographic endless belt.

13. The process cartridge according to claim 10, wherein said meandering-preventive member and said position detection member are each disposed in a non-image formation region of said beltlike substrate.

14. The process cartridge according to claim 10, wherein the surface of said beltlike substrate has a spectral reflectance higher than that of the surface of said position detection member.

15. The process cartridge according to claim 14, wherein the spectral reflectance of the surface of said beltlike substrate and the spectral reflectance of the surface of said position detection member is in a difference of 5 or more.

16. The process cartridge according to claim 10, wherein said beltlike substrate comprises a colored layer containing a colorant, and the colored layer has a layer thickness of from 40 μm to 200 μm.

17. The process cartridge according to claim 16, wherein said colorant is a white pigment.

18. The process cartridge according to claim 10, wherein said beltlike substrate has a glossiness of 35 or more.

19. The process cartridge according to claim 10, which has at least one of a light-projecting part of a position detection sensor and a light-receiving part of the position detection sensor.

20. The process cartridge according to claim 19, wherein said position detection sensor is a reflection type position detection sensor.

21. The process cartridge according to claim 10, which has a density detection sensor.

22. An electrophotographic apparatus comprising:
an electrophotographic photosensitive member for holding a toner image thereon;
a charging means for charging the electrophotographic photosensitive member electrostatically;
an exposure means for forming an electrostatic latent image on the electrophotographic photosensitive member having been charged by the charging means;
a developing means for developing the electrostatic latent image formed on the electrophotographic photosensitive member by the exposure means, to form a toner image on the electrophotographic photosensitive member;
an intermediate transfer belt which is to form a contact zone between itself and the electrophotographic photosensitive member, for secondarily transferring to a transfer material the toner image transferred after the toner image has been primarily transferred thereto from the electrophotographic photosensitive member; and
a primary transfer means for transferring the toner image primarily from the electrophotographic photosensitive member to the intermediate transfer belt at the contact zone therebetween;
said intermediate transfer belt comprising a beltlike substrate, a meandering-preventive member and a position detection member; wherein;
said meandering-preventive member is disposed on the inner-periphery side of one end portion of said beltlike substrate;
said position detection member is disposed on the outer-periphery side of the other end portion of said beltlike substrate; and
said meandering-preventive member and said position detection member are kept apart in a distance of from 200 mm to 250 mm in the width direction of the electrophotographic endless belt.

23. The electrophotographic apparatus according to claim 22, which comprises a process cartridge in which at least said electrophotographic photosensitive member and said intermediate transfer belt are integrally supported and which is detachably mountable to the main body of the electrophotographic apparatus.

24. The electrophotographic apparatus according to claim 22, wherein said meandering-preventive member and said position detection member are kept apart in a distance of from 220 mm to 250 mm in the width direction of the electrophotographic endless belt.

25. The electrophotographic apparatus according to claim 22, wherein said meandering-preventive member and said position detection member are each disposed in a non-image formation region of said beltlike substrate.

26. The electrophotographic apparatus according to claim 22, wherein the surface of said beltlike substrate has a spectral reflectance higher than that of the surface of said position detection member.

27. The electrophotographic apparatus according to claim 26, wherein the spectral reflectance of the surface of said beltlike substrate and the spectral reflectance of the surface of said position detection member is in a difference of 5 or more.

28. The electrophotographic apparatus according to claim 22, wherein said beltlike substrate comprises a colored layer containing a colorant, and the colored layer has a layer thickness of from 40 μm to 200 μm.

29. The electrophotographic apparatus according to claim 28, wherein said colorant is a white pigment.

30. The electrophotographic apparatus according to claim 22, wherein said beltlike substrate has a glossiness of 35 or more.

31. The electrophotographic apparatus according to claim 22, which has a position detection sensor.

32. The electrophotographic apparatus according to claim 31, which comprises a process cartridge in which at least one of a light-projecting part of said position detection sensor and a light-receiving part of said position detection sensor, said intermediate transfer belt and said electrophotographic photosensitive member are integrally supported and which is detachably mountable to the main body of the electrophotographic apparatus.

33. The electrophotographic apparatus according to claim 31, wherein said position detection sensor is a reflection type position detection sensor.

34. The electrophotographic apparatus according to claim 22, which has a density detection sensor.

35. The electrophotographic apparatus according to claim 34, which comprises a process cartridge in which said density detection sensor, said intermediate transfer belt and said electrophotographic photosensitive member are integrally supported and which is detachably mountable to the main body of the electrophotographic apparatus.
